(19) United States
(12) Patent Application Publication
(10) Pub. No.: US 2007/0299699 A1
(43) Pub. Date: Dec. 27, 2007

(54) System and Method for Initiation of Payment of a Member Cost Portion of Insurance Claim Expenses

(76) Inventors: Thomas Policelli, West Hartford, CT (US); Dave Kisch, Apple Valley, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/620,526

(22) Filed: Jan. 5, 2007

Related U.S. Application Data
(60) Provisional application No. 60/756,291, filed on Jan. 5, 2006.

(51) Int. Cl. G06Q 40/00

(52) U.S. Cl. 705/4; 705/40

(57) ABSTRACT

A method and system for providing initiation of payment of a member's cost portion of insurance claims to a provider includes an insurance company adjudicating claims received from a provider, and directing a financial institution having an association with the member to pay for the member's cost portion of the insurance claims on the member's behalf. The system for initiating payment of member's cost portion of claims to providers includes a processor communicatively coupled to a database and an optional financial institution database and processing component communicatively coupled to the processor.

### CROSS REFERENCE TO RELATED APPLICATION

The present invention claims priority to U.S. Provisional Patent Application No. 60/756,291, filed on Jan. 5, 2006, which is herein incorporated by reference in its entirety.

### FIELD OF THE INVENTION

The present invention relates to initiation of payment of a member cost portion of insurance claim expenses to a service provider, wherein a financial institution associated with the member is directed to pay the member cost portion, as determined by an insurance company, to the service provider on behalf of the member.

### BACKGROUND

Healthcare bill payment collection processes may be problematic for health care providers, e.g., physicians and hospitals, (“providers”). Currently, when a member covered under an insurance policy or plan receives a service, for example, a healthcare service from a healthcare provider, the provider files one or more insurance claims with the member's insurance company. The insurance company then calculates the portion of the cost that the insurance company pays in accordance with the terms of the member's insurance policy (“the covered portion”) and calculates the portion of the cost that is the member's responsibility to pay (“the non-covered portion”). The insurance company pays the provider the covered portion of the service cost. The provider must then bill the member for the non-covered portion, which the member may or may not pay.

Consequently, providers bear the risk of member non-payment. This risk is increasing as higher deductible health plans tied to health savings accounts (HSAs) grow in popularity and the member's portion of healthcare costs continues to increase.

### SUMMARY

To address these issues, a system and method is provided wherein an insurance company notifies a financial institution of a member's non-covered portion of service costs due to a provider, which results in the financial institution paying the member's cost portion to the provider. This may shift the risk of member non-payment from the service provider to the financial institution. According to the system and method, an insurance company adjudicates insurance claims, pays the covered portion of the service costs to the provider, and notifies a financial institution associated with the member to pay the member's cost portion for the services that is due to the provider. The financial institution bills the member for the payments made to the provider, for example, on a periodic basis.

In some implementations, a financial institution extends a line of credit to a member and enters into an agreement with the financial institution that the financial institution will pay the member's cost portion of claims to providers on the member's behalf. The member also may provide information concerning their association with the financial institution to the insurance company. When the member receives a service, such as a health-related service from a healthcare provider, the provider files insurance claims with the member's insurance company. The insurance company adjudicates the claims and calculates the covered portion of the service cost payable by the insurance company and the non-covered portion of the service cost payable by the member. Then, based upon the member's association with the financial institution, the insurance company generates an instruction or payment request, which is transmitted to the financial institution. The instruction or payment request instructs the financial institution to pay the member's non-covered cost portion to the service provider. When the financial institution pays the member cost portion of claims on the member's behalf, the financial institution draws on the member's line of credit. The member is able to repay the financial institution directly through checks or money transfers or through payroll deduction. For example, by collecting funds from payroll deduction, the financial institution may lower the chance of incurring bad debt due to non-payment by the member.

According to one implementation, a method for initiating payment to a service provider includes: storing member data including an association between a member and a financial institution; receiving one or more insurance claims from a provider for one or more services rendered to the member; adjudicating the one or more claims to calculate a member's cost portion for the one or more services; and generating payment instructions based upon the member data, wherein the payment instructions notifies the financial institution associated with the member to pay the member's cost portion to the provider.

Additionally, a system for initiating payment to a service provider includes a database for storing member data including an association between a member and a financial institution and a processor coupled to the database for receiving one or more insurance claims from a provider for one or more services rendered to the member, adjudicating the one or more claims to calculate a member's cost portion for the one or more services, and generating payment instructions based upon the member data, wherein the payment instructions notify the financial institution associated with the member to pay the member's cost portion to the provider. The system optionally may further include a financial institution database and processing component configured for receiving the payment instructions from the processor and for paying the member's cost portion to the provider.

While the detailed description of the invention is provided in the context of healthcare services and health insurance, the system and method of the present invention may be implemented to enable non-covered costs that are the member's responsibility to pay under any type of insurance plan, such as home, vehicle, property, liability or other.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1a provides a flowchart of a method for initiating payment to a provider for a member portion one or more claims.

FIG. 1b provides a flowchart of a method for a financial institution to pay a provider for services rendered to a member.

FIG. 1c provides a flowchart of another method for payment of providers on a member's behalf.

FIG. 2 depicts a network that may implement claim payment methods.

FIG. 3 depicts a claim payment system that may process claims and initiate payment on behalf of the enrollee.

### DETAILED DESCRIPTION

A system and method enable payment and/or initiation of payment of a member cost portion of claims to providers for services provided to a member. Payment may be initiated by an insurance company notifying a financial institution of a member's cost portion of insurance claims, where the member has entered into an agreement with the financial institution that member cost portions of claims will be paid by the financial institution on the member's behalf. The member may repay the financial institution directly through checks, funds from health savings vehicles such as HSAs, or through payroll deduction. The system and method may be implemented in a network for health insurance, such as a proprietary network, and may be configured to support claims processes such as claims adjudication, claim settlement coordination with providers for employer portions of claims, and initiation of claim payment to providers for a member's cost portion of claims by a financial institution.

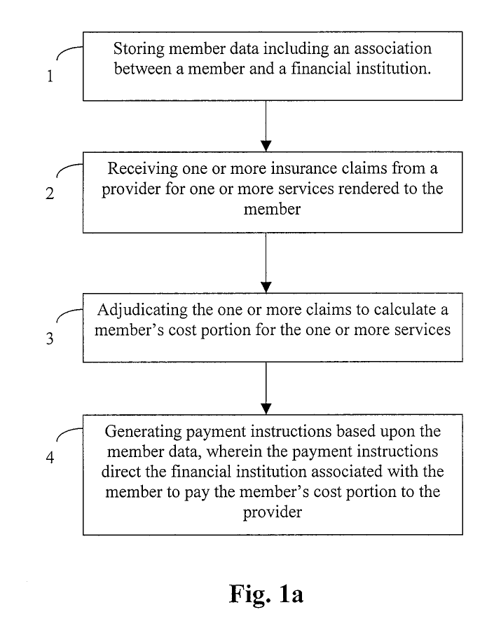

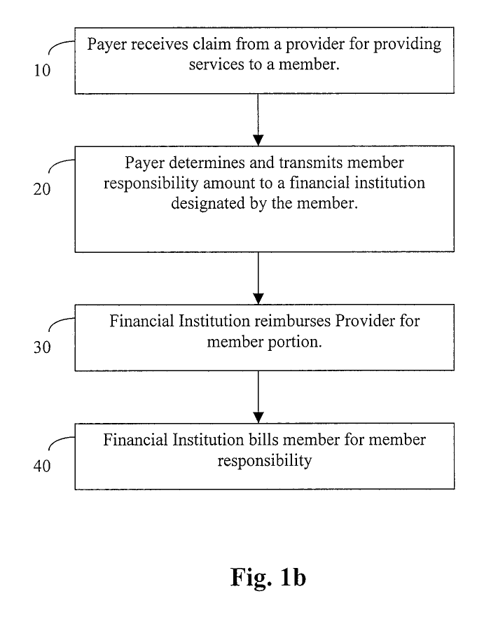

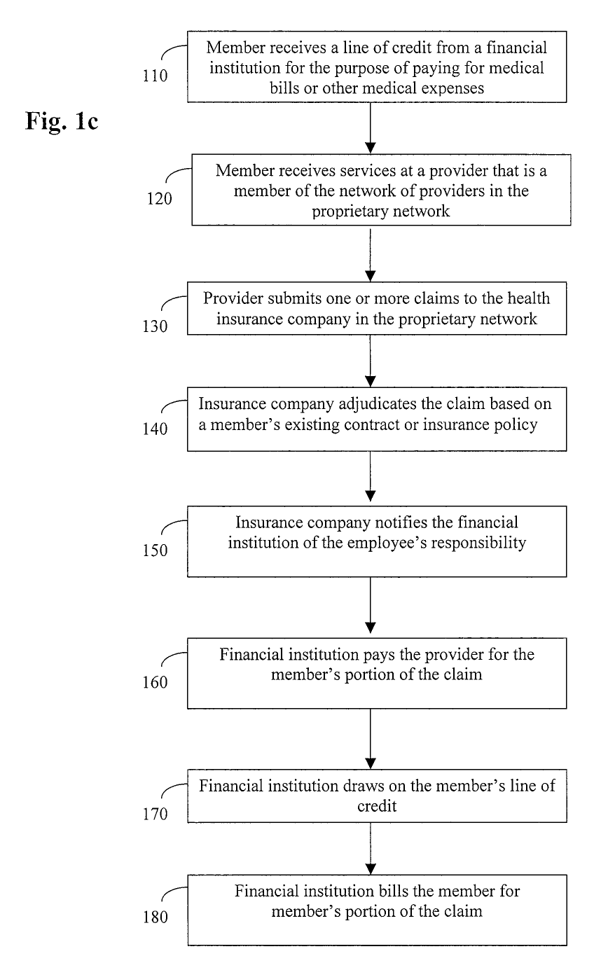

FIG. 1a provides a flowchart of a method for initiating payment to a provider for a member cost portion of claims. The method includes an insurance company storing (1) member data including an association between a member and a financial institution. Insurance claims are received (2) for one or more services rendered to the member, and the insurance claims are adjudicated (3) to calculate a member's cost portion for the one or more services. Then the insurance company generates (4) payment instructions based upon the member data, where the payment instructions notify the financial institution associated with the member to pay the member's cost portion due to the provider.

FIG. 1b provides a flowchart of a method for a financial institution to pay a provider a member responsibility amount for services rendered to a member. The method includes a payer, such as an insurance company, receiving (10) one or more claims from a provider for services rendered to a member. The payer determines and transmits (20) the member responsibility amount to a financial institution designated by the member, and the financial institution reimburses (30) the provider for the member responsibility, e.g., member's cost portion of the claim. Periodically, the financial institution bills (40) the member for the member responsibility paid on their behalf, and the member may repay the financial institution by check, from healthcare accounts, such as a flexible spending account, and HSA, or HRA, or through payroll deduction, for example.

FIG. 1c provides a flowchart of another method for a financial institution paying providers a member's cost portion on a member's behalf. According to FIG. 1c, a member receives (110) a line of credit from a financial institution affiliated with a network for the purpose of paying for medical bills or other medical expenses. In some implementations the line of credit is equal to the member's maximum out-of-pocket expense for covered services under the member's insurance policy. In addition, the member may notify their insurance company of the line of credit received. The member receives (120) services at a provider that is a member of the network, and the provider submits (130) one or more claims to the health insurance company in the network. The health insurance company is responsible for adjudicating (140) the claim based on a member's existing contract and an employer's plan design, calculating and paying the employer portion of the claim, and calculating the employers portion of the claim owed to the provider. Subsequently, the insurance company notifies (150) the financial institution of the member's responsibility, and the financial institution pays (160) the provider for the member's portion of the claim on behalf of the member. As a result, the financial institution direct settles with the provider without member involvement. Upon payment to the provider, the financial institution draws (170) on the member's line of credit, bills (180) the member for their portion of the claim, and may be repaid by the member via, for example, check, from healthcare accounts, or through payroll deduction.

Thus, according to exemplary implementations, the network provides for the coordination of claim settlement because an notifies a financial institution that one or more member claims need to be settled, and the financial institution both initiates a credit transaction with the member and pays the provider on behalf of the member. This is in contrast to the provider communicating to the member to pay the member's portion of the claim. Provider payment of the member portion of claims by the financial institution may facilitate providing a reliable healthcare services payment system. In addition, providers may work with the insurance company to determine a member's portion of the plan rather than dealing directly with the member.

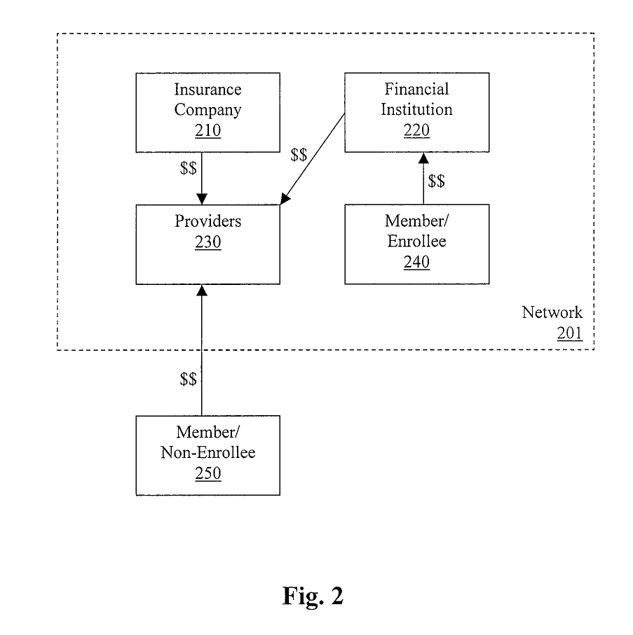

The above-mentioned methods may be implemented in a system organized under a network, such as the network 201 depicted in FIG. 2. In FIG. 2, network 201 includes an insurance company 210, a financial institution 220, a group of providers 230, and member/enrollees 240. As can be seen by the arrows between the entities in the network 201, providers 230 are paid by the insurance company 210, e.g., for the employer portion of claims, and by the financial institution 220, e.g., for the member/enrollee 240 cost portion of the claims. Member/enrollees 240 are then responsible for paying the financial institution 220. This is in contrast to a member/non-enrollee 250 that is responsible for paying providers 230 directly.

In certain configurations, members 240 and providers 230 join the network 201 by enrolling or by entering into a contract with insurance company 210 and/or financial institution 220. Member enrollment may include meeting requisite eligibility requirements set by an employer and/or financial institution. For example, the member may be required to have a minimum credit score before being extended a line of credit by the financial institution, or may be required to allow payroll deduction as an option for repaying the financial institution. The member may be required give authorization to the financial institution to pay member cost portions of claims on the member's behalf, and/or that the member will repay the financial institution for services rendered. In addition, as part of the enrollment process, the member may be required to notify his/her insurance company of the line of credit extended by the financial institution. Providers 230 may join the network by entering into a network contract that may require the provider to agree to not collect co-pays, deductibles, or co-insurance directly from the member/enrollee 240 at the time of service, to not send bills directly to member/enrollees 240 after the time of service, and/or to agree to send bills directly to the insurance company. In addition, providers may be required to agree with the financial institution that the financial institution will pay to the provider a member's cost portions of claims on behalf of the member. It will be understood by those of skill in the art that a network may have various configurations and include various entities and implement various agreements. For example, numerous provider groups may be included in the network. In another example, the network may include other entities (e.g. a holding company) that serve to cooperate with one or more of the providers, financial institution and/or the insurance company in order to comply with various laws, regulations, or policies.

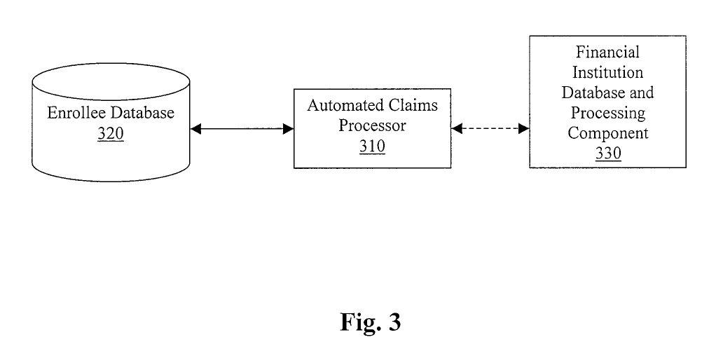

Bills and/or claims sent to the insurance company by providers may be processed by a claim payment system, such as the system depicted in FIG. 3. The system of FIG. 3 includes a processor 310 and a database 320 for storing member information. In addition, the claim payment system may optionally include a financial institution database and processing component 330. Claims sent electronically or via mail to the insurance company may be submitted to the processor 310 where the claim is adjudicated in order to determine the employer and member responsibilities. Processor 310 also queries database 320 to determine whether the member is an enrollee in the network. If the member is an enrollee, then processor 310 may generate payment instructions notifying a financial institution to pay the member's cost portion to the provider. For example, the generated instructions may be routed to financial institution database and processing component 330 so that the financial institution pays the member's cost portion to the provider. Accordingly, the provider is paid the member's cost portion by the financial institution, and the financial institution bills the enrollee for the paid amount. If the member is not an enrollee, the provider may submit a bill directly to the member for payment, and accordingly, the automated claims processor 310 is not prompted to send a message to the financial institution regarding the member non-enrollee responsibility. In certain configurations, the insurance company in the network maintains the automated claims processor 310 and enrollee database 320, while the financial institution maintains the optional database and processing component 330. It will be understood, however, that the claim payment system may have various configurations and be incorporated into other software and database systems. For example, claims that do not automatically adjudicate at the automated claims processor 310 may be automatically routed to a manual work queue (not shown) for manual adjudication, and a claims specialist may manually route the appropriate claim data related to a member's cost portion to a financial institution database and processing component 330.

In view of the above-described claim payment system, claims may be adjudicated in real-time upon receipt from the provider, automatically submitted to the financial institution, and paid to the provider. This may reduce the amount of time a provider waits between billing the member and receiving payment for services rendered and simplify the provider's billing process.

Furthermore, the claim payment system may be configured so that multiple claims for services rendered to the member may be adjudicated, the member cost portion paid to the financial institution, and the member billed for a consolidated amount in one statement issued periodically from the financial institution. This may be useful for keeping track of out-of-pocket expenses because a billing statement generated by an entity in the network and provided to the member may include a listing of the member cost portions that correspond to each claim, in addition to a total amount owed by the member to the financial institution.

According to certain implementations, claim adjudication by the insurance company may be based on a single contract applicable to enrollees and non-enrollees. This provides for an adjudication system that may be based on a single fee schedule for claim adjudication so that claims may be adjudicated in the same way for a group of employees, some enrolled in the network and some that are not. In addition, the insurance company may pay the employer portions of member claims regardless of the member's status as an enrollee or non-enrollee in the network. Accordingly, the front end of a network's claim adjudication system that involves claim adjudication and provider payment on behalf of employers may remain relatively unchanged. However, it will be understood by those of skill in the art, that a claims adjudication system may be modified according to plan requirements. For example, the claims adjudication system may send the financial institution a report of all claims processed for members in the payment plan daily or weekly.

In a further implementation, providers may agree to pay a transaction fee in return for payment of the member's portion of the claim from the financial institution. The transaction fee may be a set amount per transaction, e.g., $5 per transaction, a percentage of the member's portion, e.g. 1-15 percent, or a mixture of transaction fees and set amounts, for example, where the provider is charged a fixed fee for claims under a predetermined amount and a percentage of the fee is charged to the provider for claims over the predetermined amount. It will be understood by those of skill in the art, that transaction fees may be formatted in any suitable fashion, including those described above, and with various other modifications. For example, a transaction fee of $5 may be charged to the provider when a member's portion of the claim totals up to $25, and when the member's portion of the claim exceeds $25, the transaction fee may be increased to $10. Further, a transaction fee structure may involve a percentage scale where the transaction fee percentage increases as the member responsibility increases.

In a particular example, a claim may be adjudicated for a member enrolled in the payment plan where the allowed amount is $2,500, which may be the same whether the member was enrolled in the payment plan or not. In this example the member's responsibility is $500 out of the $2,500. The financial institution pays to the provider $500 less a 12% transaction fee ($60) for a net payment of $440. Subsequently the provider may adjust their records to reflect that the remaining balance owed to the provider is $0.

Payment of the enrollee responsibility portion of the claim by the financial institution may be sent along with an explanation of benefits or invoice that details the pertinent information on the claim including the patient's name, date of service, billed charges, allowed amount, patient's responsibility, the financial institution's transaction fee, and the net amount paid to the provider. Alternatively, payment and an explanation of benefits or invoice may be sent to the provider separately for privacy purposes. For example, both the payment and the explanation of benefits may be assigned a common invoice number or numbers so that the provider is able to match payment with the explanation of benefits.

In another implementation, a member enrolled in the payment plan may receive a discount on their cost portion of the claim responsibility. For example, the discount may be a percentage of the member's claim responsibility or may be a fixed amount. In a particular example, a member may receive a billing statement from the financial institution covering all visits made to providers in the network. The billing statement may show the member's responsibility before the discount, e.g., a $500 of out-of-pocket expenses for the statement period, and the member's responsibility after the discount, e.g., $475 after a 5% discount or a discount of $25. Discounting the member's out-of-pocket expenses may provide an incentive for enrolling in the network's payment plan, and the incentive may be reinforced by providing a member's savings on their billing statements. Furthermore, a member's explanation of benefits may also include information on member savings.

In some implementations, an enrollee may be required to allow payroll deduction as an option for repayment of the member portion of claims. Then, for example, after an enrollee has not paid the financial institution for a pre-determined period of time, e.g., a grace period of 30 days, the enrollee's payroll may be deducted a pro-rated amount until the financial institution collects the full amount due. However, where the enrollee's payroll is deducted, the enrollee may choose to pay their bill in full, e.g., by personal check, or by transferring funds from an HSA or HRA, in which case the enrollee's payroll would no longer be deducted from.

Furthermore, the payment system may be configured similar to a credit card so that once a member's payment for services has been due for a predetermined of time, interest is charged on the amount due. In some configurations, the interest rate may range from 1-25 percent.

According to various implementations, an enrollee periodically receives statements from the financial institution, e.g., monthly, that provides the enrollee with confirmation, where applicable, that they are receiving a discount, that payroll deduction is in force, and/or that the amount due is incurring interest. For methods that implement payroll deduction, the enrollee may not be considered delinquent after a period of non-payment because after a grace period payroll deduction is initiated. Therefore, the periodic statements may show that payroll deduction is in force, but delinquency related processing may, in some instances, be suppressed so that statement messages, delinquent amounts added to minimum payments due, outbound calls and letters are not communicated to the enrollee.

According to certain configurations, the healthcare network may implement a cardless system, where the insurance company stores member enrollment data electronically. For example, at the point of service, a provider may verify eligibility of a member using the insurance company's website, confirm with the member that they are enrolled in the network, and submit claims directly to the insurance company for services rendered. Accordingly, and consistent with the implementations described above, the provider does not collect payment from the member at the point of service or bill the member directly for services rendered, and instead continues to submit claims to the insurance company in the same manner other claims are submitted.

In further configurations, the network's payment plan may be combined with an integrated access device provided by the network. The access device may include a card, code or other means of access to financial and/or health account information. The access device may serve as an insurance card and hold a member's identification information, contain a medical history or provide access to a medical history, provide access to a line of credit, a health savings account, a flexible spending account, and may provide purse management functionalities in which the member may designate where or how funds should be allocated when paying providers or for other healthcare products or services. In this configuration, the integrated access device may serve as both an insurance card and a payment vehicle for the enrollee's out-of-pocket liability.

According to certain configurations, claims adjudication systems, such as those described in U.S. Pat. No. 5,359,509, having an issue date of Oct. 25, 1994, and entitled “Health Care Payment Adjudication and Review System”, which is incorporated herein by reference in its entirety, may be implemented along with the disclosed inventive methods and systems.

In addition, claims processing systems, such as those described in U.S. patent application Ser. No. 11/562,131, having an application date of Nov. 21, 2006, and entitled “Method and System for Enabling Automatic Insurance Claim Processing”, which is incorporated herein by reference in its entirety, may be implemented along with the disclosed inventive methods and systems.

It should be understood that the method and system according to the present invention may be implemented using various combinations of software and hardware as would be apparent to those of skill in the art and as desired by the user. The present invention may be implemented in conjunction with a general purpose or dedicated computer system having a processor and memory components.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A method for initiating payment to a provider for a member portion of one or more claims, comprising:
storing member data including an association between a member and a financial institution;
receiving one or more insurance claims from a provider for one or more services rendered to the member;
adjudicating the one or more claims to calculate a member's cost portion for the one or more services; and
generating payment instructions based upon the member data, wherein the payment instructions notify the financial institution associated with the member to pay the member's cost portion to the provider.

2. The method of claim 1, wherein receiving the one or more insurance claims comprises receiving one or more medical insurance claims.

3. The method of claim 1, further comprising entering into an agreement with the financial institution that the financial institution will pay to the provider the member portion of the claim upon receiving the generated payment instructions.

4. The method of claim 3, further comprising receiving an indication from the financial institution that the member's cost portion is paid to the provider.

5. The method of claim 4, further comprising receiving an indication from the financial institution that the member repaid the financial institution.

6. The method of claim 1, further comprising entering into an agreement with the provider that a transaction fee is to be charged to the provider for payments of the member's cost portion made to the provider by the financial institution.

7. The method of claim 6, further comprising the financial institution paying the member's cost portion to the provider less the transaction fee.

8. The method of claim 7, further comprising the financial institution billing the member for the member portion of the claim responsibility.

9. The method of claim 1, further comprising entering into an agreement with the member that the member will receive a discount for repayment to the financial institution of the paid member's cost portion.

10. The method of claim 9, further comprising the financial institution billing the member for the member's cost portion less the discount.

11. The method of claim 1, further comprising receiving an indication from the financial institution that the member's cost portion is paid to the provider.

12. The method of claim 11, further comprising receiving an indication from the financial institution that the member repaid the financial institution.

13. The method of claim 11, further comprising receiving an indication from the financial institution that the member has not repaid the financial institution for a predetermined period of time.

14. The method of claim 13, further comprising generating a message to implement a payroll deduction process on the member's payroll for repayment.

15. The method of claim 1, wherein the association between the member and the financial institution comprises data related to a line of credit extended to the member by the financial institution.

16. A system for initiating payment to a service provider, comprising:
a database for storing member data including an association between a member and a financial institution; and
a processor coupled to the database for receiving one or more insurance claims from a provider for one or more services rendered to the member, adjudicating the one or more claims to calculate a member's cost portion for the one or more services, and generating payment instructions based upon the member data, wherein the payment instructions notify the financial institution associated with the member to pay the member's cost portion to the provider.

17. The system of claim 16, further comprising a financial institution database and processing component configured for receiving the payment instructions from the processor and for paying the member's cost portion to the provider

18. The system of claim 16, wherein the database is accessible by a provider to confirm the member association with the financial institution.

19. The system of claim 16, further comprising an electronic card system, wherein the database is accessible by the electronic card system, the electronic card system associated with integrated insurance cards configured to hold member data.

20. The system of claim 16, wherein the one or more insurance claims comprises one or more medical insurance claims.
